(19) United States
(12) Patent Application Publication
(10) Pub. No.: US 2019/0002055 A1
(43) Pub. Date: Jan. 3, 2019

(54) All Limb Powered And Steered Front Wheel Drive Land Vehicle

(71) Applicant: Christopher Drake Reed, Dalton, GA (US)

(72) Inventor: Christopher Drake Reed, Dalton, GA (US)

(21) Appl. No.: 15/635,234

(22) Filed: Jun. 28, 2017

(51) Int. Cl. B62M 1/12; B62J 1/00; B62K 5/02; B62K 3/00; B62M 1/36; B62M 3/06; B62M 9/00

(52) U.S. Cl. CPC B62M 1/12; B62J 1/00; B62K 5/02; B62M 2009/002; B62M 1/36; B62M 3/06; B62M 9/00; B62K 3/005

(57) ABSTRACT

An all limb powered and steered front wheel drive land vehicle comprises a seat (133), a front wheel (115), a rear wheel (155), a front drive component (66) and a frame (1) wherein; the seat (133) and a rear wheel (155) are mounted on a rear portion of the frame (1); wherein the front wheel (115) and front drive component (66) are mounted on a front portion of the frame (1); wherein the front drive component (66) comprises a drive mechanism (61) for driving the front wheel (115) and a connecting rod (23)comprising two hand grips for driving the drive mechanism (61) and a lever (31) comprising two foot pegs for driving the connecting rod (23) and a fulcrum (105) mounting the lever (31) to the frame (1). Employing all four limbs of a comfortably seated rider for power and steering, this high performance bicycle converts into a tricycle by removing the rear wheel (155) and replacing it with an axle (192) and a left rear wheel (190) and a right rear wheel (191).

### FIELD OF THE INVENTION

This invention relates to a two or three wheeled manually powered land vehicle, and in particular, to an improved performance front wheel drive land vehicle that employs all four limbs of the rider for power and steering.

### RELATED ART

Most manually powered land vehicles involve a rider leaning forward while kicking left then right with only their feet to rotate a rear wheel or wheels and controlling steering with their arms. The potential driving power of the arms in these configurations remains unused. Some cycles have been configured to use the power from all four limbs of a rider to power the back wheel, or wheels, while only the arms control steering as shown in U.S. Pat. No. 9,315,230 B2. Other configurations use the legs to power the rear wheel, or wheels, and the arms to power the front wheel and control steering as shown in U.S. Pat. No. U.S. 7,021,639 B2. These configurations are limited in power from the lack of an anchor to push or kick from. Similar configurations are also limited in navigation stability because of the left then right motion of the arms and/or legs.

Therefore, what is clearly needed is a configuration that employs all four limbs of the human body that effectively solves the problems mentioned above.

### SUMMARY OF THE INVENTION AND ADVANTAGES

This invention employs all four limbs of the human body to power and steer only the front wheel with the rider in a comfortable seated position. A seat with a backrest provides an anchor to push and kick from. A lever transmits power from the foot pegs to a connecting rod. The connecting rod transmits power from the lever and the hand grips on the connecting rod to the crank. The crank transmits power to the front wheel via a sprocket and a chain. This configuration uses two strokes for each rotation of the crank. Said strokes will be referred to in this document as a primary stroke and a secondary stroke. The primary stroke starts with the hand grips extended all the way out from the rider and the foot pegs positioned all the way in toward the rider. In this stroke, the rider pulls back and downward with both hands on the hand grips while kicking out with both feet on the foot pegs. This results in one half of a rotation of the crank. The secondary stroke starts with the hand grips pulled all the way in toward the rider and the foot pegs kicked all the way out. In this stroke, the rider pushes out and upward, away from the backrest, with both hands on the hand grips while relaxing or pulling back both legs. This results in a completed rotation of the crank. Repetition of the primary stroke and secondary stroke keeps the cycle in motion. Steering is achieved by extending the limbs on one side of the body out further than the other while shifting weight to the left or right depending on the desired direction. Powering and steering the machine the same time becomes easy with very little practice. This machine also easily converts from a bicycle into a tricycle by simply removing the rear wheel and inserting an axle with two wheels. This results in a high performance land vehicle that handles very well.

This invention, like many other manually powered vehicles, is an environmentally clean form of transportation that does not consume fossil fuels or emit green house gases. Bicycles and tricycles enable people and their property to travel farther and faster on roads than traveling on foot. Many people in this and other countries, such as China, rely heavily on manually powered vehicles to commute to and from work or school. This particular invention is also a great form of exercise for both upper and lower body.

### BRIEF DESCRIPTION OF THE DRAWINGS

These and other advantages of the present invention will become more readily appreciated as the same becomes better understood by reference to the following detailed description when considered in connection with accompanying drawings, wherein:

FIG. 1 is a perspective view of the right side of Embodiment 1 with a rider in a seated position.

FIG. 2 is a perspective view of the front and right side of Embodiment 1 of the present invention.

FIG. 3 is a perspective view of the back and right side of Embodiment 1 of the present invention.

FIG. 4A is a partial exploded perspective view of the front portion of Embodiment 1 and 4 of the present invention.

FIG. 4B is a partial exploded perspective view of the rear portion of Embodiment 1, 2, and 3 of the present invention.

FIG. 4C is a partial exploded perspective view of the front portion of Embodiment 2 of the present invention with a circular drive sprocket.

FIG. 4D is a partial exploded perspective view of the front portion of Embodiment 3 of the present invention with a conventional 10 speed drive train.

FIG. 5 is a perspective view of the back and right side of Embodiment 4 of the present invention, wherein the rear wheel is replaced with an axle and two wheels.

### DETAILED DESCRIPTION

### Embodiment 1

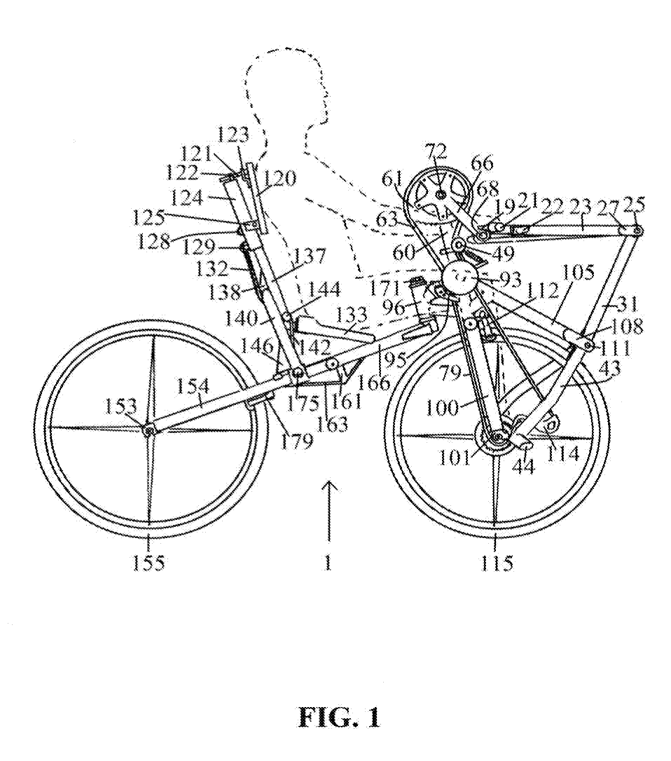

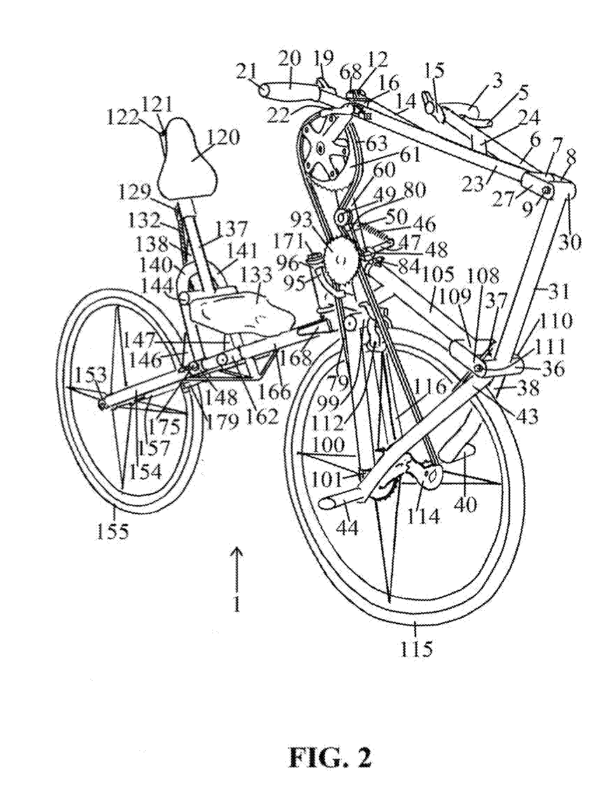

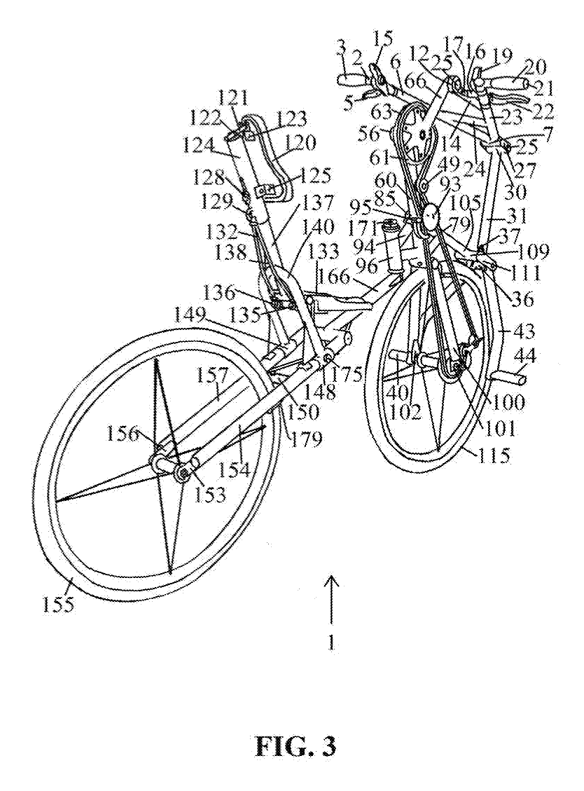

FIGS. 1-4B show a first embodiment of the all limb powered and steered front wheel drive land vehicle of the present invention. The bicycle comprises a frame 1, a conventional front wheel 115, a conventional rear wheel 155, a lever with two foot pegs 31, a connecting rod with two hand grips 23, a seat 133, and a driving mechanism 66. The conventional front wheel 115, driving mechanism 66, lever 31, and connecting rod 23 are mounted to the front portion of frame 1. The conventional rear wheel 155, and the seat 133 are mounted to the rear portion of frame 1.

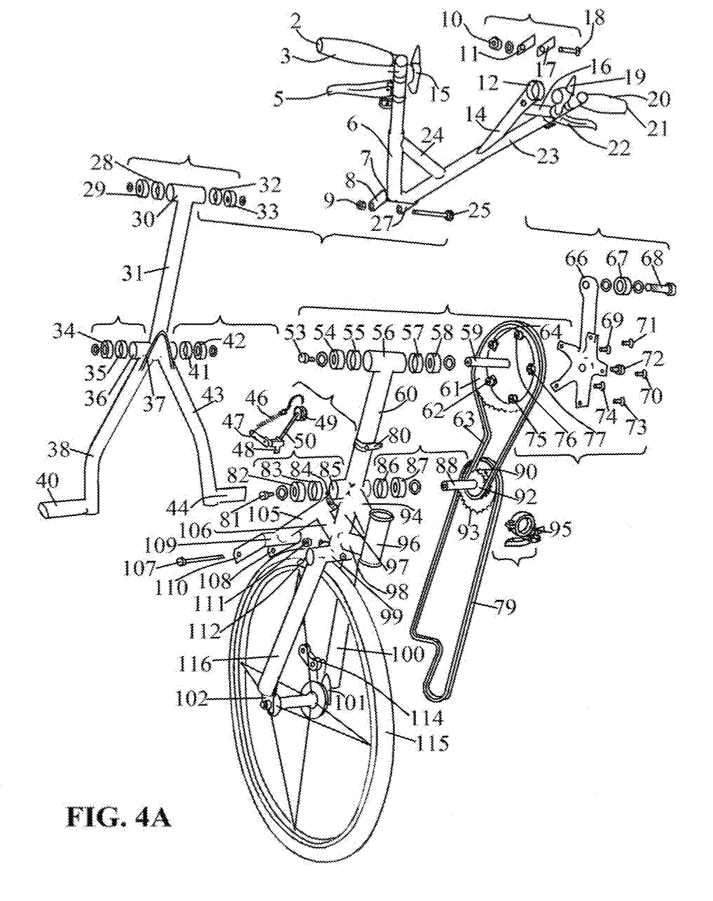

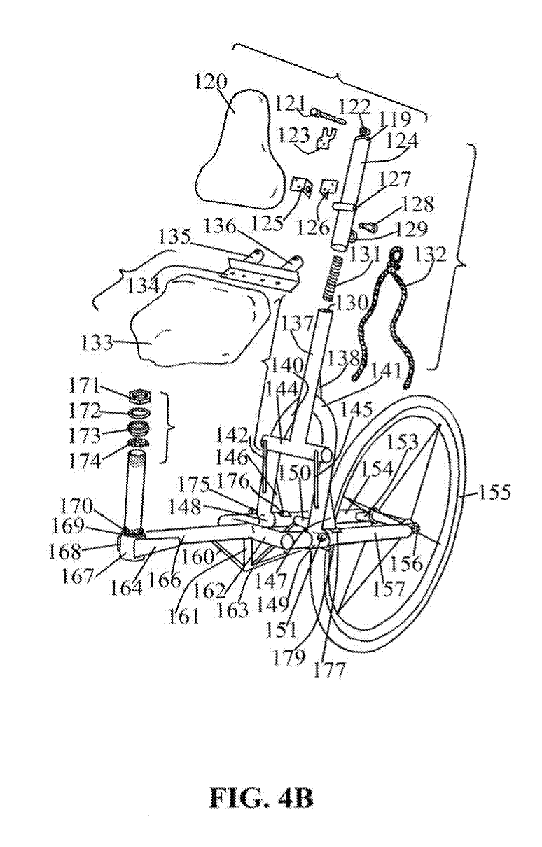

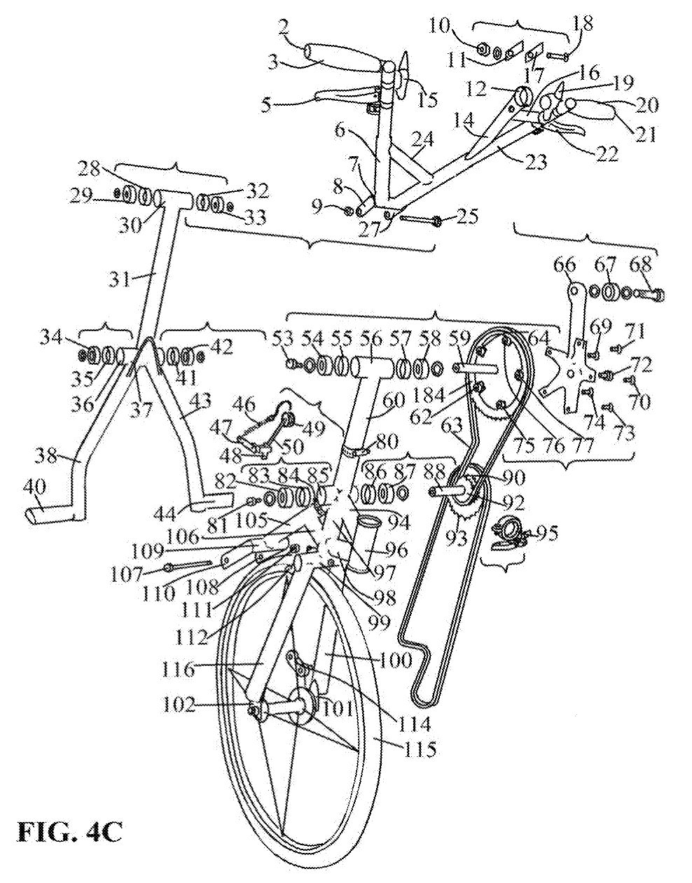

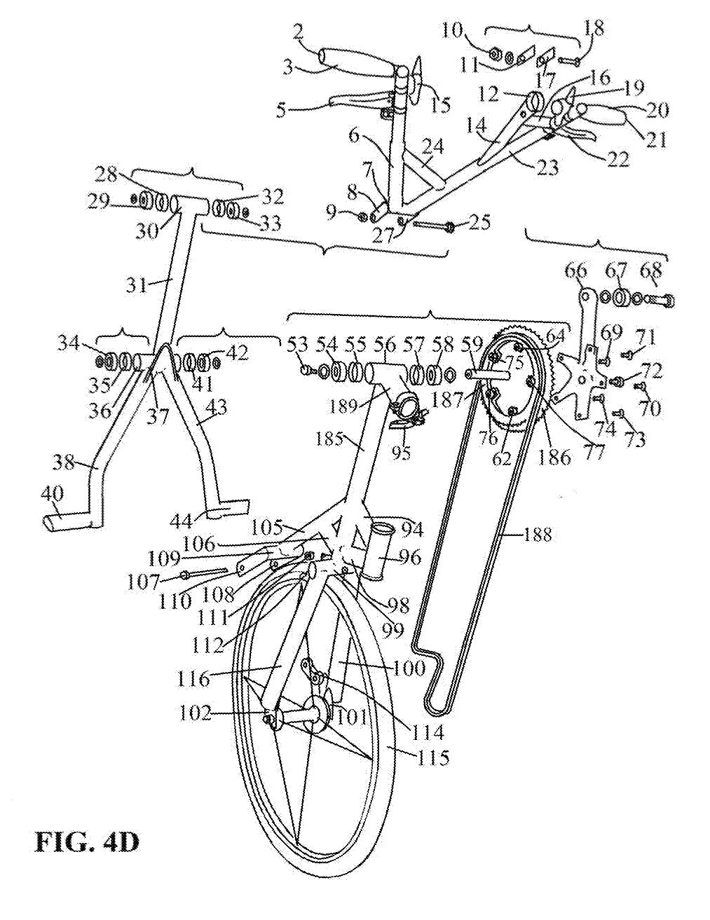

As shown in FIG. 4A The conventional front wheel 115 slides into the slots on the left front wheel dropout 102 and the right front wheel dropout 101 which also supports a conventional rear derailleur 114. The left front wheel dropout 102 and the right front wheel dropout 101 are rigidly attached to the left front wheel fork 116 and the right wheel fork 100. Said wheel forks extend from the front brake mount 99 at equal, opposing, and appropriate angles as to accommodate the length of the hub of the chosen conventional front l 115. The front brake mount 99 supports a conventional front brake 112. The drive train support tube 97 extends up from the front brake mount 99 parallel to the head tube 96 which is fifteen degrees to a vertical reference line. The drive train support tube 97 is rigidly attached at ninety degrees to the transmission bracket 85. The transmission bracket 85 is parallel to the front brake mount 99 and is rigidly attached to the bottom bracket tube 60 at ninety degrees. The bottom bracket tube 60, which is parallel to the drive train support tube 97, supports the bottom bracket 56 at a ninety degree angle. The head tube 96 firmly connects to the drive train support tube 97 via the head tube support 98 and also connects to the transmission bracket 85 via the front derailleur mount 94 in a triangular fashion. One end of the rocker support tube 105 is welded to the transmission bracket 85 and is supported by a rocker post support 106. The other end is rigidly attached to the rocker fork junction 109 and suspended over the conventional front wheel 115. The rocker fork junction 109 is rigidly attached to rocker support tube 105 at 90 degrees on said end and is parallel to the transmission bracket 85. The left rocker main flange 110 and the right rocker main flange 108 are welded to the rocker fork junction 109. The bolt holes in the left and right rocker main flange 110, 108 must be parallel to the bore of the bottom bracket 56 and the bore of the transmission bracket 85.

Conventional bearings are used for the left and right transmission bracket bearings 82, 87. Said bearings are held in place with the left and right transmission bracket retaining rings 83, 86. These rings are inserted and rigidly attached in the transmission bracket 85 at a depth that makes the left and right transmission bearings 82, 87 flush with the rims of the transmission bracket 85. Other commercially available bearing assemblies will also work well here.

Conventional bearings are used for the left and right bottom bracket bearings 54, 58. Said bearings are held in place with the left and right bottom bracket retaining rings 55, 57. These rings are inserted and rigidly attached in the bottom bracket 56 at a depth that makes the left and right bottom bracket bearings 54, 58 flush with the rims of the bottom bracket 56. Other commercially available bearing assemblies will also work well here.

A conventional crank 66 rotates the cam shaped drive sprocket 61 shown in FIG. 1-4A. It is six and three quarter inches long. The cam shaped sprocket 61 has three more teeth on the apex side of the axis point than the opposing side. The opposing side has twenty one teeth. The apex side has twenty four. Therefore, the apex side of the cam shaped drive sprocket 61 pulls more drive chain 63 in one rotation of the conventional crank 66 than the smaller side of the axis point does. This design takes advantage of the more powerful primary stroke which uses the muscles of both arms and both legs of the rider. Only the arms power the secondary stroke so the smaller side of the cam shaped drive sprocket 61 should pull the drive chain 63 during said stroke.

As shown in FIG. 4A, the cam shaped drive sprocket 61 should be mounted with the apex at ninety degrees counter clockwise to the conventional crank 66 for optimum performance. However, the cam shaped drive sprocket 61 can be rotated and/or flipped to ten possible positions to create greater resistance for different selected muscle groups. Doing so will likely have a negative effect on the bikes performance but a better targeted work out.

The cam shaped drive sprocket 61 is mounted to the conventional crank 66 with drive sprocket bolts 69, 70, 71, 73, and 74 then secured with sprocket hex nuts 62, 64, 75, 76, and 77. The conventional crank 66 is bolted to the crank axle 59 with a crank axle bolt 72 then inserted through the left and right bottom bracket bearings 54, 58 and secured with a bottom bracket axle retaining bolt 53.

The crank bearing 67 is a conventional bearing and is bolted on to the conventional crank 66 with the crank bearing bolt 68. Said bolt has a shank long enough to accommodate the selected bearing with a washer on each side and also has a reverse threading to prevent it from working loose during operation.

The drive chain slave sprocket 92 comprising fourteen teeth, transmission low sprocket 90 comprising fourteen teeth, and the transmission high sprocket 93 comprising twenty eight teeth are rigidly attached to the transmission axle 88. The drive chain slave sprocket 92 is put into motion by, and dedicated to, the drive chain 63. The wheel chain 79 is driven by either the transmission low sprocket 90 or the transmission high sprocket 93 depending on which is selected by the rider. The wheel chain 79 is moved to and held on the selected sprocket with a conventional front derailleur 95. Said derailleur clamps onto the front derailleur mount 94. This assembly allows for higher wheel to crank ratios without the need for an over sized drive sprocket. It also provides a barrier between the drive chain 63 and the wheel chain 79. The oscillating motion of the drive chain 63 that results from the cam shaped sprocket 61 would otherwise disrupt the operation of the conventional rear derailleur 114.

The transmission axle 88 is mounted into the transmission bracket 85 by inserting it trough the right transmission bearing 87 and the left transmission bearing 82. The transmission axle retaining bolt 81 holds the assembly in place.

The tension pulley bearing 49 comprises a conventional bearing with two over sized washers on each side. The tension pulley arm 50 is six inches long and made of three sixteenths diameter steel round-bar. Lighter alloys can also be used. One inch of each end of the tension pulley arm 50 is bent at ninety degrees in opposing directions and parallel to one another. The tension pulley bearing 49 is mounted onto one end of the tension pulley arm 50 and retained by mushrooming said end. The remaining end is inserted through holes in the tension pulley bracket 48. The tension pulley bracket 48 is made from a two inch long by one half inch wide by one eighth inch thick piece of steel flat bar. Lighter alloy metals such as aluminum will also work well here. One half inch of each end are bent at ninety degrees in the same direction and parallel to one another. A one inch mounting tab for the tension pulley bracket 48 is made from one half inch wide by one eighth inch thick flat bar and welded at ninety degrees and parallel to the middle of said bracket. Holes are drilled in each bent end of the tension pulley bracket 48 to accommodate the tension pulley arm 50. The tension pulley spring arm 47 is made from four inches of half inch wide by eighth inch thick steel flat bar with eighth inch holes drilled in each end. The tension pulley arm 50 is firmly attached to the tension pulley spring arm 47 at a ninety degree angle.

The tension pulley bracket 48 is mounted to the rocker support tube 105 with a conventional hose clamp 84. The tension pulley bearing 49 is then placed on the drive chain 63. One end of the tension pulley spring 46 is inserted through the hole on the tension pulley spring arm 47 and the remaining end is held on the bottom bracket tube 60 with a conventional hose clamp 80. Tension on the drive chain 63 is adjusted by sliding and securing the conventional hose clamp 80 up or down the bottom bracket tube 60.

The lever 31 comprises a left foot peg 40 that connects to a left rocker leg 38, and a right foot peg 44 that connects to a right rocker leg 43 at ninety degree angles. The left rocker leg 38 and the right rocker leg 43 connect to the rocker body 31 via the main rocker bracket 36 on which they swing. The rocker body 31 is rigidly attached to the main rocker bracket 36 at ninety degrees left to right and back ten degrees front to back. This manipulates the rider to use a more downward kicking motion during the primary stroke. Therefore, more muscle groups of the lower back are used producing a stronger kick. Said connections are reinforced with a rocker gusset 37 over the main rocker bracket 36, the rocker gusset 37 comprises of three sixteenths round-bar which is bent in half to the necessary angle to place it in the middle. One end of the rocker gusset 37 is firmly attached to the left rocker leg 38 while the other end is firmly attached to the right rocker leg 43. The bent angle is rigidly attached to the rocker body 31. The left and right rocker legs 38, 43 are both bent back in at an angle in the middle so as to be parallel with the plane of the front wheel 115, this prevents them from stretching out so far that the left and right foot pegs 40, 44 hit the ground while leaning into a turn.

Conventional bearings are used for the left and right bracket rocker bracket bearings 34, 42. Said bearings are held in place with the left and right main rocker bracket retaining rings 35, 41. These rings are inserted and firmly attached in the main rocker bracket 36 at a depth that makes the left and right main rocker bracket bearings 34, 42 flush with the outer rims. Other bearing assemblies will also work well here.

The rocker body 31 is rigidly connected to the top rocker bracket 30 at ninety degrees. Conventional bearings are used for the left and right top rocker bracket bearings 29, 33. Said bearings are held in place with the left and right top rocker bracket retaining rings 28, 32. These rings are inserted and firmly attached in the top rocker bracket 30 at a depth that makes the left and right top rocker bracket bearings 29, 33 flush with the rims. Other commercially available bearing assemblies will also work well here.

The main rocker bracket 36 is mounted to frame 1 by placing it between the left and right rocker main flange 110, 108. Then it is attached with the rocker main bracket bolt 107, and held in place with a rocker main hex nut 111.

Conventional left and right hand grips 3, 20 are used to cover and soften the left and right hand bars 2, 21. The left and right hand bars 2, 21 are welded to the left and right push bars 6, 23 parallel to on another, and at equal and opposing angles that are dependent on the dimensions of the chosen conventional crank 66. Conventional controls are used for the left derailleur control 15, left brake control 5, right derailleur control 19, and the right brake control 22. Said controls are clamped on the left push bar 6 and the right push bar 23 close to the left hand bar 2 and the right hand bar 21 so that the rider doesn't have to let go of the left or right hand grips 3, 20 to stop or change sprockets. The left push bar 6 and the right push bar 23 are rigidly connected to each other with a push bar brace 24 and rigidly connected at the push bar fork junction 7. This makes the assembly, as a whole, stronger. The push bar brace 24 is placed so as to allow clearance for the drive sprocket 61 and the drive chain 63 while supporting the left push bar 6 close to the middle. The push bar fork junction 7 also supports the left and right push bar forks 8, 27 at 90 degree angles and parallel to the left and right hand bar 2, 21. Bolt holes are drilled in the left push bar fork 8 and the right push bar fork 27, and should be parallel to the left hand bar 2 and the right hand bar 21. A crank bearing ring 12 is rigidly attached to the right push bar 23 with the connecting rod 14. Said attachment is reinforced with the crank bearing ring brace 16.

The crank bearing ring 12 should be mounted to the conventional crank 66 next. This is done by sliding the crank hearing ring 12 over the crank bearing 67 and locking it into place with left crank hearing retainer 11 and the right crank bearing retainer 17. Said retainers are held in place with the crank bearing retainer bolt 18 and secured with the crank bearing retainer hex nut 10. Then, the top rocker bracket 30 is placed between the left and right push bar forks 8, 27. Then the push bar fork bolt 25 is inserted through the hole in the right push bar fork 27, right top rocker bracket bearing 33, left top rocker bracket bearing 29, and the hole in the left push bar fork 8. This is secured with a push bar fork hex nut 9.

The lengths of the conventional crank 66, connecting rod 23, rocker body 31 and the distance from the center of the bottom bracket 56 to the center of the main rocker bracket 36 are crucial and dependent on one another to operate properly. Variations to any of these will result in different stroke lengths and/or placements of the left and right foot pegs 40, 44 and the left and right hand bars 2, 21. On the present invention, the distance between the centers of the two axis points of the conventional crank 66 is six and three quarters of an inch. The distance from the center of the crank bearing ring 12 to the center of the top rocker bracket 30 is eighteen and one quarter inch. The distance from the top rocker bracket 30 to the main rocker bracket 36 is fifteen inches. The distance from the center of the bottom bracket 56 to the center of the main rocker bracket 36 is twenty five and one eighth inch. The distance from the center of the main rocker bracket 36 to the bottom of the left and right foot pegs 40, 44 is fifteen inches. These dimensions are well suited for people who are between five feet tall and six feet, three inches tall. However, for taller or shorter people, or if a different size conventional crank is used, then these dimensions will need to change accordingly.

Moving on to FIG. 4B, the conventional rear wheel 155 slides into the slots on the left rear wheel dropout 156 and the right rear wheel dropout 153. The left rear wheel dropout 156 is welded onto one side of one end of the left rear wheel fork 157. The right rear wheel dropout 153 is welded onto one side of one end of the right rear wheel fork 154. The left and right rear wheel forks 157, 154 are made of sixteen gauge, one and one quarter inch diameter steel tubing at a length dependent on the radius of the conventional rear wheel 155. At this point the left and right seat adjustment glides 149, 148 should be threaded and slid into place on the left and right rear wheel forks 157, 154. The remaining ends of the left and right rear wheel forks 157, 154 are rigidly connected to the rear wheel fork junction 162 at ninety degree angles and parallel to one another. The middle and opposite side of the rear wheel fork junction 162 is rigidly connected at ninety degrees to the rear frame main tube 166. The bottom side of said connections are reinforced with the frame truss post 161, straight truss wire 160, and a bent truss wire 163. The straight truss wire 160 connects to the frame truss post 161 and to the rear frame main tube 166. The bent truss wire 163 is bent at an angle so as to connect the frame truss post 161 to the left and right rear wheel forks 157, 154 in the middle. The remaining end of the rear frame main tube 166 is connected to the conventional steerer tube 167 parallel to the head tube 96. Said connection is reinforced on the left and right side with the left and right rear frame tube reinforcement plates 164, 168. The rear brake mount 150 connects the left and right rear wheel forks 157, 154 at a ninety degree angle eight inches from the rear wheel fork junction 162. This should allow for six to seven inches of seat adjustment. The seat is secured in the chosen position with the left and right seat glide adjustment bolt 151, 175. The rear brake mount 150 also supports a conventional rear break 179.

The left seat leg 141 and the right seat leg 140 are each bent on one end with a curve to a forty five degree angle. The bent ends are attached with the curves opposed in a Gothic style arch with the bases parallel. The remaining ends are connected to the left seat adjustment glide 149 and the tight seat adjustment glide 148. The left seat leg gusset 147 and the right seat leg gusset 146 are attached to the bottom of the back sides of the left and right seat legs 141, 140 parallel with the left and right wheel forks 154, 157. The left fork pad 177 is placed half way between the left seat leg gusset 147 and the left rear wheel fork 157 and welded to the left seat leg gusset 147. The right fork pad 176 is placed half way between the right seat leg gusset 146 and the left rear wheel fork 154 and welded to the right seat leg gusset 146. The seat tube junction 144 is connected across the front sides of the left seat leg 141 and the right seat leg 140 at a ninety degree angle and parallel to the rear wheel fork junction 162. One end of the left seat guide 145 is attached at a half of an inch in from the left side of the seat tube junction 144. The other end is attached to the left seat leg 141 three inches from the bottom. One end of the right seat guide 142 is attached at a half of an inch in from the right side of the seat tube junction 144. The other end is attached to the right seat leg 140 three inches from the bottom. The bottom of the seat tube 137 is connected to the middle of the seat tube junction 144 at a ninety degree angle and also connects at the apex of the arch of the left and right seat leg 141, 140. This connection is reinforced with a one eighth inch thick seat tube gusset 138. The remaining end of the seat tube 137 is suspended. over the seat tube junction 144 and is parallel to the bases of the left and right seat legs 141, 140. A quarter inch hole is then drilled through the top back side of the seat tube 137 at one quarter inch from the top. Then the seat tube hex nut 130 is welded over the hole on the inside of the seat tube 137.

The backrest 120 is made of plywood and shaped like a triangle that is eight inches wide and nine inches long. Other composite materials will work well here. The corners are rounded off, and the left and right sides are rounded in. The front side is covered with a thin layer of foam and then a layer of vinyl which is attached at the back. Thumb tacks are used here but staples would work well too. The left backrest hinge 126 and the right backrest hinge 125 are attached to the bottom backside of the backrest 120 parallel and opposing one another with drywall screws, but wood screws will work too. The backrest adjustment retainer 123 has a slot on one end to accept the shank of the backrest adjustment screw 121. The backrest adjustment retainer 123 is attached at the center of the top of the backrest 120 with the slotted end pointing up. This prevents the backrest 120 from flopping forward.

The backrest cylinder 124 is an eight inch long piece of sixteen gauge, one and one quarter inch diameter steel tubing. Other alloys would work well here. The top is capped with a sixteen gauge steel cylinder cap 119. The backrest hex nut 122 is welded atop the cylinder cap. The backrest pivot bar 127 is rigidly attached horizontally to the front side of the backrest cylinder 124 three inches from the bottom. A backrest tether ring 129 is vertically connected to the back side of the backrest cylinder 124 one inch from the bottom. A three inch slot is cut in the backrest cylinder 124 at one inch up from the backrest tether ring 129. This accommodates the backrest cylinder retaining bolt 128.

The seat 133 is made from a ten inch by ten inch piece of plywood. Plastic or composite materials will also work well here. The two front corners are rounded inward to allow room for the riders legs. The bottom side is notched where the rounded corners meet so the seat can catch and pivot on the rear frame main tube 166 wherever the seat is adjusted to. The seat 133 is covered with foam and vinyl and attached at the back with thumb tacks. Staples would also work well here. The seat bracket 134 is made of a six inch long piece of sixteen gauge angle iron. It is attached to the back and bottom side of the seat 133 with drywall screws. Wood screws would also work well here. The left and right seat bracket extension 136, 135 are made of seven eighths diameter tubing with holes drilled on one end for tethering. The left and right seat brackets 136, 135 are rigidly attached to backside and center of the seat bracket 134.

The seat spring 131 is inserted into the backrest cylinder 124 before mounting the cylinder over the seat tube 137 and securing it with the backrest cylinder retaining bolt 128. The left and right seat bracket extension 136, 135 are placed under the seat tube junction 144 between the left and right seat guide 145, 142. Said seat bracket extensions 135, 136 are then tethered to the backrest tethering ring 129 with a polypropylene rope 132 and with enough tension to pull the backrest cylinder 124 down over the seat tube 137 three inches.

In FIG. 4A and FIG. 4B, the front portion of frame 1 and the rear portion of frame 1 should be pivotally connected via the head tube 96 and the conventional steerer tube 167 next. The bottom head set bearing 170 is placed on the lower crown race 169 before inserting the steerer tube 167 up through the conventional head tube 96. Next, the upper bearings 174 are installed and followed by the upper race 173 head set lock washer 172, and secured with the headset lock nut 171.

### Embodiment 2

FIG. 4C shows a second embodiment of the all limb powered and steered land vehicle of the present invention, which differs from Embodiment 1 only in that: the cam shaped drive sprocket 61 has been removed and replaced with a conventional circular drive sprocket 184 comprising of an even number of teeth on both sides of the axis point. The conventional circular drive sprocket 184 is mounted to the conventional crank 66 with drive sprocket bolts 69, 70, 71, 73, and 74 then secured with sprocket hex nuts 62, 64, 75, 76, and 77. The conventional crank 66 is bolted to the crank axle 59 with the crank axle bolt 72, then inserted through the left and right bottom bracket bearings 54, 58 and secured with a bottom bracket axle retaining bolt 53.

### Embodiment 3

FIG. 4D shows a third embodiment of the all limb powered and steered land vehicle of the present invention, which differs from Embodiment 1 only in that: the cam shaped drive sprocket 61, transmission bracket 85, drive train support tube 97, and bottom bracket tube 60 have been removed and replaced with a conventional high drive sprocket 186, conventional low drive sprocket 187, lengthened drive train support tube 185, and a front derailleur support tube 189. One end of the lengthened drive train support tube 185 is connected to the front brake mount 99 and extends upward and parallel to the angle of the head tube 96 which is fifteen degrees to a vertical reference line. The lengthened drive train support tube 185 is fourteen inches long and the remaining end is firmly attached to the bottom bracket 56. A front derailleur support tube 189 is rigidly attached to the back of the bottom bracket 56 at an angle parallel to the front derailleur mount 94.

The conventional high drive sprocket 186 and the conventional low drive sprocket 187 are mounted to the conventional crank 66 with drive sprocket bolts 69, 70, 71, 73, and 74 then secured with sprocket hex nuts 62, 64, 75, 76, and 77. The conventional crank 66 is bolted to the crank axle 59 with a crank axle bolt 72, then inserted through the left and right bottom bracket bearings 54, 58 and secured with a bottom bracket axle retaining bolt 53. The conventional bicycle chain 188 is moved to and held on the selected drive sprocket with a conventional front derailleur 95 that clamps onto the front derailleur support tube 189.

### Embodiment 4

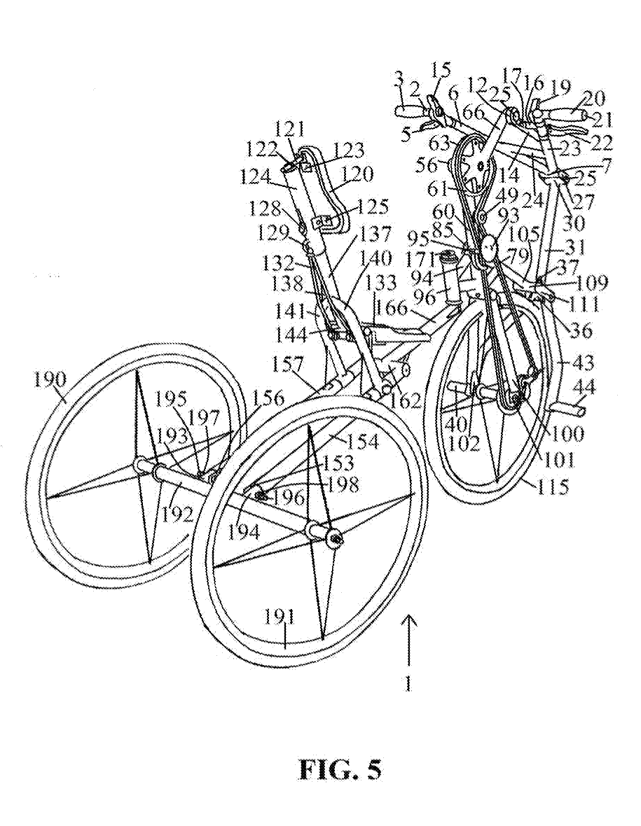

FIG. 5 shows a fourth Embodiment of the all limb powered and steered land vehicle of the present invention,which differs from Embodiment 1 only in that: the rear wheel 155 has been removed and replaced with a rear axle 192, a left conventional rear wheel 190, and a right conventional rear wheel 191. The rear axle 192 is comprised of one inch diameter sixteen gauge steel tubing and is twenty eight inches long. Other alloys would also work well here. A left axle insert 193 and a right axle insert 194 are welded to the rear axle 192 at ninety degrees and parallel to one another. Said inserts comprise of one inch diameter sixteen gauge steel tubing and are seven inches long with a three eighths inch hole drilled in each at one inch from the rear axle 192. The left axle insert 193 and the right axle insert 194 are centered and separated on the rear axle 192 at a distance that is dependent on the hub length of the chosen conventional rear wheel 155.

The rear axle 192 is mounted onto frame 1 by inserting the left and right axle inserts 193. 194 into the left and right rear wheel forks 157, 154. The left and right axle insert bolts 195, 196 are then inserted through the slots of the left and right drop outs 156, 153 and the drilled holes of the left and right axle inserts 193, 194. The assembly is then secured with the left and right axle hex nuts 197, 198.

The invention has been described in an illustrative manner, and it is to be understood that the terminology which is used is intended to be in the nature of words of description rather than limitation. Obviously, many modifications and variations of the present invention are possible in light of the above detailed description. For example, the number of teeth on the cam shaped drive sprocket 61 could be proportionately reduced on both sides of the axis point to make it smaller. The loss in crank 66 to front wheel 115 ratio could be supplemented by adding teeth to the transmission low and high sprocket 90, 93. This new version would have essentially the same drive characteristics as the present invention. It is, therefore, to be understood that within the scope of the attached claim, the invention may be practiced otherwise than as specifically described. The invention is described by the claim.

What is claimed is:

1. The all limb powered and steered front wheel drive land vehicle comprising a seat, a front wheel, a rear wheel, a front drive component, and a frame; wherein the seat and rear wheel are mounted on the rear portion of the frame; wherein the front wheel and front drive component are mounted on the front portion of the frame; wherein the front drive component comprises a drive mechanism for driving the front wheel and a connecting rod comprising two hand grips for driving the drive mechanism and a lever comprising two foot pegs for driving the connecting rod and a fulcrum mounting the lever on the front portion of the frame.

2. The all limb powered and steered front wheel drive land vehicle in claim 1, wherein the lever bar forks in three directions at the fulcrum: one bar swinging on the left side of the front wheel and one bar swinging on the right side of the front wheel and one opposing bar pivotally attaching to the connecting rod.

3. The all limb powered and steered front wheel drive land vehicle in claim 1, wherein the seat is suspended from a backrest that is supported by a spring.

4. The all limb powered and steered front wheel drive land vehicle in claim 1, wherein the seat can be adjusted by sliding and securing it to the frame.

5. The all limb powered and steered front wheel drive land vehicle in claim 1, wherein the front wheel drive component comprises a high and a low drive sprocket.

6. The all limb powered and steered front wheel drive land vehicle in claim 1, wherein the drive mechanism comprises a transmission between the drive sprocket and the front wheel.

7. The all limb powered and steered front wheel drive land vehicle in claim 1, wherein the drive mechanism comprises a drive sprocket with an even number of teeth on both sides of the axis point.

8. The all limb powered and steered front wheel drive and vehicle in claim 1, wherein the drive mechanism comprises a cam shaped drive sprocket with more teeth on the apex side of the axis point than on the opposing side.

9. The all limb powered and steered front wheel drive land vehicle in claim 1, wherein the rear wheel can be replaced with an axle and two wheels thus becoming a tricycle.

10. The all limb powered and steered front wheel drive land vehicle comprising a seat, a front wheel, a left rear wheel, a right rear wheel, a front drive component, and a frame; wherein the seat, left rear wheel and right rear wheel are mounted on the rear portion of the frame; wherein the front wheel and front drive component are mounted on the front portion of the frame; wherein the front drive component comprises a drive mechanism for driving the front wheel and a connecting rod comprising two hand grips for driving the drive mechanism and a lever comprising two foot pegs for driving the connecting rod and a fulcrum mounting the lever on the front portion of the frame.

11. The all limb powered and steered front wheel drive land vehicle in claim 10, wherein the lever bar forks in three directions at the fulcrum: one bar swinging on the left side of the front wheel and one bar swinging on the right side of the front wheel and one opposing bar pivotally attaching to the connecting rod.

12. The all limb powered and steered front wheel drive land vehicle in claim 10, wherein the seat is suspended from a backrest that is supported by a spring.

13. The all limb powered and steered front wheel drive land vehicle in claim 10, wherein the seat can be adjusted by sliding and securing it to the frame.

14. The all limb powered and steered front wheel drive land vehicle in claim 10, wherein the front wheel drive component comprises a high and a low drive sprocket.

15. The all limb powered and steered front wheel drive land vehicle in claim 10, wherein the drive mechanism comprises a transmission between the drive sprocket and the front wheel.

16. The all limb powered and steered front wheel drive land vehicle in claim 10, wherein the drive mechanism comprises a drive sprocket with an even number of teeth on both sides of the axis point.

17. The all limb powered and steered front wheel drive land vehicle in claim 10, wherein the drive mechanism comprises a cam shaped drive sprocket with more teeth on the apex side of the axis point than on the opposing side.
